(19) United States
(12) Patent Application Publication
(10) Pub. No.: US 2021/0342822 A1
(43) Pub. Date: Nov. 4, 2021

(54) COMPLIANCE BASED DATA TRANSACTION NETWORK

(71) Applicants: Maria Esther Lau, Sacramento, CA (US); Kevin Wayne Hartig, San Jose, CA (US)

(72) Inventors: Maria Esther Lau, Sacramento, CA (US); Kevin Wayne Hartig, San Jose, CA (US)

(21) Appl. No.: 17/243,008

(22) Filed: Apr. 28, 2021

Related U.S. Application Data
(60) Provisional application No. 63/019,551, filed on May 4, 2020.

(51) Int. Cl. G06Q 20/36; G06F 21/62; G06F 21/60; G06Q 20/40; G06Q 20/06

(52) U.S. Cl. CPC G06Q 20/363; G06F 21/6254; G06Q 2220/00; G06Q 20/401; G06Q 20/065; G06F 21/602

(57) ABSTRACT

A distributed compliance system permits exchange and storage of compliance data that is required to be collected by institutions. The distributed compliance system utilizes blockchain technology to securely exchange sensitive data via a compliance network layer. A transaction network layer is also implemented to provide transactionally incentivized compliance with and exchange of sensitive data.

This application claims the benefit of U.S. Provisional Patent Application Ser. No. 63/019,551, filed May 4, 2020, the contents of which are incorporated herein by reference.

### BACKGROUND

### 1. Field

This application is directed to the field of compliance networks. In particular, the application is directed to compliance networks implementing blockchain functionality in order to provide enhanced security.

### 2. Description of the Related Art

Blockchain technology, such as Bitcoin and Ethereum, have introduced methods for providing digitization of money, processing of transactions, smart contracts, and record-keeping. Recently, the European Union enacted the European Union's General Data Protection Regulation (GDPR). This regulation impacted the process of Know Your Customer (KYC) compliance that had been implemented by financial institutions. Legal and technical clashes between GDPR and KYC processes continue to plague the financial system.

Proper implementation of blockchain technology in the financial system can leverage KYC compliance as a native protocol on a digital transactions network which can then be used to increase customer engagement and accommodate global economic activity by integrating trust and data security into the foundations of the next digital age. By building automated safety and regulatory protocols into a digital transactions network, onboarding times for corporate and correspondent banking can be drastically reduced, global transactions can rapidly be settled, and GDPR-KYC regulatory systems would operate complementarily.

### SUMMARY

Briefly described, aspects of the present disclosure relate to distributed compliance networks.

An aspect of the present disclosure is a distributed compliance system. The distributed compliance system comprising: at least one user operably connected to a compliance network layer; at least one institution operably connected to the compliance network layer; at least one processing node operably connected to the compliance network layer, wherein the at least one processing node is adapted to receive sensitive data from the at least one user and verify compliance of the sensitive data received with a set of compliance regulations; wherein the at least one processing node stores the sensitive data and is adapted to provide profile data to the at least one institution based on the sensitive data of the at least one user upon request of the at least one institution; and wherein the profile data is processed by the at least one institution and the processed profile data informs the at least one institution as to whether the sensitive data of the at least one user complies with the set of compliance regulations.

Another aspect of the present disclosure is a method for establishing compliance with compliance regulations. The method comprising; transmitting from at least one user sensitive data related to the at least one user, wherein the sensitive data is transmitted over a compliance network layer; receiving at a processing node the sensitive data related to the at least one user; processing the sensitive data related to the at least one user to verify compliance of the sensitive data with a set of compliance regulations; generating profile data based on the sensitive data related to the at least one user; receiving a request about the at least one user from at least one institution; transmitting from the processing node to the at least one institution profile data regarding the at least one user; and determining if the at least one user is compliant with the set of compliance regulations based on the profile data.

### BRIEF DESCRIPTION OF THE DRAWINGS

FIG. 1 is a diagram of the distributed compliance system showing a compliance network layer.

FIG. 2 is a diagram showing a transaction network layer.

FIG. 3 is a diagram of entities within the distributed compliance system.

FIG. 4 is a flow chart showing the uploading of sensitive data into the distributed compliance system.

FIG. 5 shows an advertising portal graphical user interface for the distributed compliance system.

FIG. 6 is a graphical user interface of the compliance records portal for the distributed compliance system.

FIG. 7 is a graphical user interface of the enterprise node portal for the distributed compliance system.

FIG. 8 is a graphical user interface for the regulatory portal for the distributed compliance system.

FIG. 9 is a data monetization portal for the distributed compliance system.

FIG. 10 is a search engine portal for the distributed compliance system.

FIG. 11 shows a graphical user interface for the distributed compliance system showing a locker.

FIG. 12 shows a graphical user interface for the distributed compliance system showing earnings.

FIG. 13 shows a graphical user interface for the distributed compliance system showing a data log.

FIG. 14 shows a graphical user interface for the distributed compliance system showing scores.

### DETAILED DESCRIPTION

To facilitate an understanding of embodiments, principles, and features of the present disclosure, they are disclosed hereinafter with reference to implementation in illustrative embodiments. Embodiments of the present disclosure, however, are not limited to use in the described systems or methods and may be utilized in other systems and methods as will be understood by those skilled in the art.

The components described hereinafter as making up the various embodiments are intended to be illustrative and not restrictive. Many suitable components and/or steps that would perform the same or a similar function as the components and/or described herein are intended to be embraced within the scope of embodiments of the present disclosure.

Advanced banking technologies, when applied to previously underdeveloped areas, such as regions of Africa, reveal the disadvantages that the underbanked have with respect to entering and taking advantage of the banking system. Those problems impacting the underbanked may also pertain to those underemployed or those in a chronic state of insufficient cash flows.

On May 25, 2018, the European Union's (EU) General Data Protection Regulation (GDPR) went into effect. This law exposes data privacy faults and obsoleteness that exist in the current process of conducting KYC.

When U.S. companies collect, retain, analyze, process, or store any personal data of EU citizens, without notification or consent to conducting previously stated activities, U.S. companies are in danger of violating EU citizens' GDPR rights to be informed of what data has been collected, and how it is being used, stored, processed, retained, or analyzed.

Prior to GDPR, all KYC data and most privacy controls had been legally held under the domain of financial enterprises and not the individual or entity account holder. Due to GDPR's international reach, the KYC process at U.S. financial enterprises finds itself at odds with GDPR. Moreover, the GDPR is set to become the international standard bearer for data privacy controls over the next few years.

GDPR rights include the ability to request a review of any results of the processing of personal data, interpretations of personal data, assessments of personal data, and to request the erasure of data.

Current KYC data is over-processed and over-exposed to threats. When enterprises set up overseas shops (servers) without considering new privacy laws such as GDPR and technology such as Blockchain, central points of failure and information security breaches multiply. The current state of KYC compliance at multiple financial companies consumes repetitive time intensive resources on retrieving, processing, analyzing, and storing the same KYC data for the same customer.

For example, a person or business may have many bank and/or financial accounts. Each account may have a KYC file containing sensitive personal data about the person or business. On a global digital scale, copies of the same KYC processes and sensitive data per customer per company are stored redundantly, exposing the vulnerabilities of this particular process. Furthermore, rejected customers' KYC data undergoes the same process, yet no account has been opened.

Institutions use information from the processed data to categorize account holders into risk classifications to determine whether an account will be opened or maintained (if already opened). KYC data may also be exposed without the customer's knowledge or consent during audits or during scheduled KYC checks for account maintenance. The continuing proliferation of duplicated, sensitive KYC data and risk management records for individuals and entities presents a nightmare scenario for enterprises whose focus should be on their product or service. The solution to data privacy and compliance obligations, whether to prevent future scandals and security breaches, is in the implementation of blockchain's capabilities for privacy of personal data and transparency of metadata. A blockchain enabled application adapted to comply with regulatory obligations is implemented in a distributed compliance system 100 discussed below.

By applying and incentivizing tasks to individuals, compliance with regulatory obligations by individuals, as well the control and maintenance of information, can be implemented by the distributed compliance system 100.

Networks connect endpoint devices, such as smart phones, computers, tablets, databases, and laptops to accessory devices such as internet of things (IoT) sensors, watches, and VR/AR glasses. This network enables digital work and transactions in real-time, thereby incentivizing activities with digitized metrics.

Networks implementing the endpoints discussed above are used in implementing and forming a distributed compliance system 100 that implements a compliance network layer 103. The compliance network layer 103 provides a layer in a network or networks that enables the secure transfer of information. The compliance network layer 103 further helps enable monetary transactions, built with native compliance automation, that enable faster verifications, onboarding, and risk management. The compliance network layer 103 supports and accommodates digitization and digital economics.

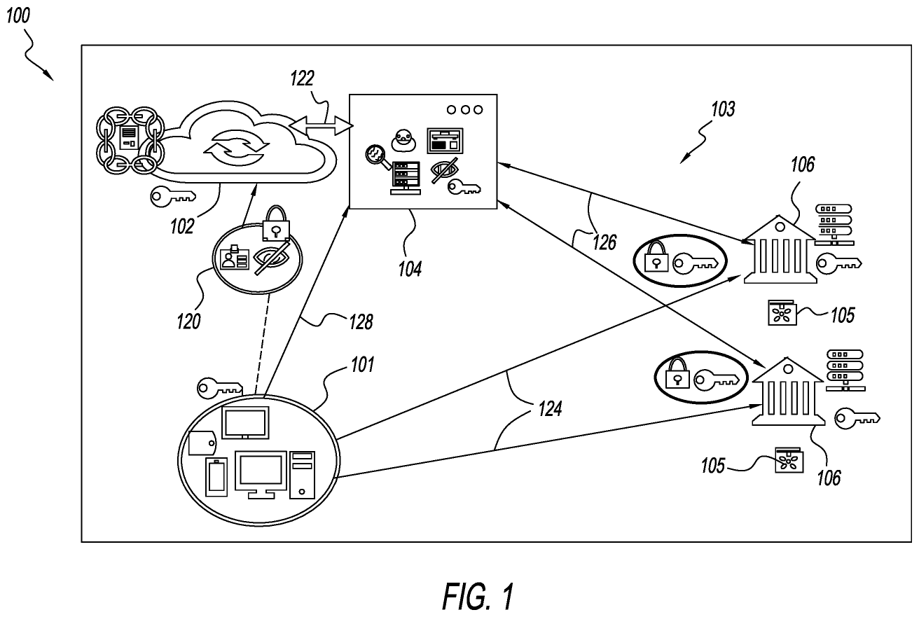

FIG. 1 shows a diagram of the distributed compliance system 100 that implements the compliance network layer 103. The compliance network layer 103 is implemented over other network services. The compliance network layer 103 mitigates and removes redundant retrieval of sensitive data, exposure of sensitive data, processing of sensitive data, analysis of sensitive data, and storing of sensitive data.

By “sensitive data” it is meant that data which contains privacy information that is used for establishing compliance with a set of compliance regulations. In an embodiment, and generally in the context of this disclosure, the data that may be utilized is data useful for providing KYC data and establishing compliance with KYC compliance regulations. While it is contemplated that this layer is utilized for KYC data, other sensitive data that may not necessarily be KYC data may also take advantage of the system, such as health related data, education related data, credit scores, property ownership, assets, and other legal related data that may be used to establish compliance with compliance regulations and business prequalification associated with those topics.

Establishing compliance with regulations related to the sensitive data may mean that the sensitive data itself is used in establishing compliance with regulations, for example the determination that the sensitive data conforms to a set of standards needed to determine if the person can partake in certain transactions, for example KYC regulation compliance. Establishing compliance with regulations may also mean that the sensitive data is processed and accessible in such a manner that the sensitive data is secure and is not needed to be stored in more than one location. Additionally, establishing compliance with regulations may mean that the sensitive data is processed and accessible and/or data representing the sensitive data is processed and accessible and the sensitive data may not need to be duplicated or stored in other locations.

In an embodiment, the compliance network layer 103 may have implemented therein an encrypted central repository of data, where sensitive data is stored and able to be retrieved. In an embodiment, storage may be located on the same network as the processing node 104. In an embodiment, the compliance network layer 103 enables clients, individuals, and businesses to process and store their own encrypted sensitive data. In an embodiment, there is a combination of a central repository of data and individuals that store encrypted sensitive data. In an embodiment, there is a distributed network of databases that store encrypted sensitive data. In an embodiment, there is a distributed network of databases and clients that store encrypted sensitive data.

Returning to FIG. 1, at 120 sensitive data is uploaded to an access point 102 of the distributed compliance system 100 by a user 101. As discussed above, “sensitive data” is data which contains information and data that is of financial, personal, or in some manner confidential in nature.

At 122, the sensitive data is processed by the processing node 104 of the compliance network layer 103. In an embodiment, processing of the sensitive data is used to create profile data. Profile data is data that is representative of the sensitive data. The compliance network layer 103 is the layer of the distributed compliance system 100 that implements the primary blockchain layer. In an embodiment, the processing node 104 is a central hub that is adapted to process the sensitive data. In an embodiment, the processing node 104 is one of a plurality of distributed processing nodes 104 that are adapted to process and analyze sensitive data that is uploaded. In an embodiment, the processing node 104 is a component of a cloud-based networking system that is adapted to process and analyze sensitive data that is uploaded.

At 124, the user 101 may transmit a public key to an institution 106. An institution 106, in the context of the distributed compliance system 100 implemented for the purpose of KYC compliance, may be a bank, lending institution, commercial enterprise, etc. A distributed compliance system 100 implemented for the purpose of healthcare may be a hospital, medical office, etc.

At 126, the institution 106 receives the public key and transmits it to the processing node 104. The processing node 104 may supply to the institution 106 the sensitive data to satisfy the KYC compliance. In an embodiment, the processing node 104 provides profile data representing the quality of the sensitive data. In an embodiment the processing node 104 provides information regarding whether the client is compliant or not. In an embodiment, the amount of information provided by the processing node 104 can be predetermined by the user 101.

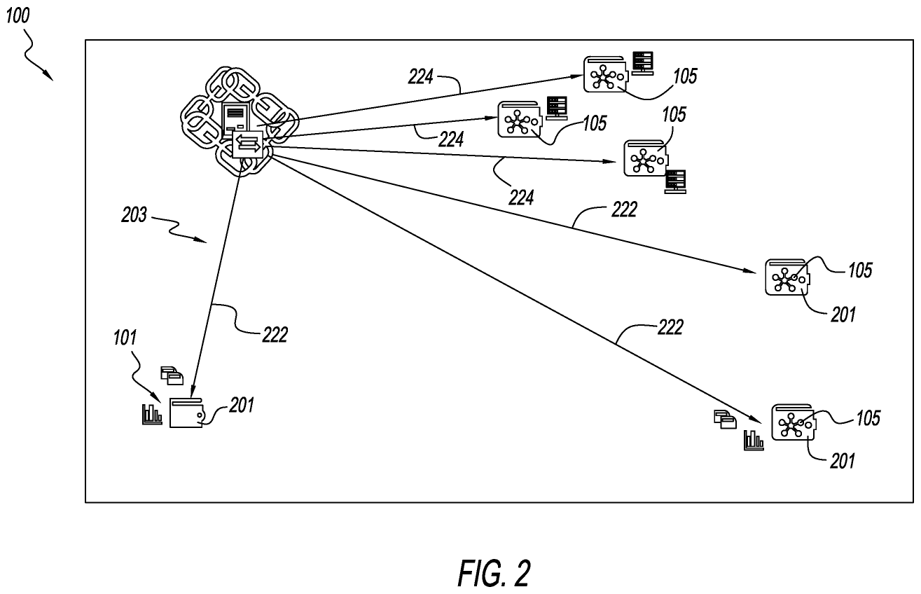

At 128, the processing node 104 further generates a token that is distributed to the user 101. The token distributed to the user 101 is payment for providing their data to the institution. In this manner users 101 are compensated for providing sensitive data within the distributed compliance system 100. The transfer of the token may be enabled by the transaction network layer 203, discussed below when referring to FIG. 2. The user 101 receives the token in a wallet 201. In an embodiment, the token is a form of cryptocurrency. In an embodiment, the token is a form of compliance certificate. In an embodiment, the token is an item or string of data that entitles a user 101 to an exchange of services. In an embodiment, tokens are provided by the processing node 104 upon transmission of sensitive data by a user 101.

Still referring to FIG. 1, when users 101 register on the distributed compliance system 100 and provide consent to KYC check requests from institutions 106, sensitive data, such as the personal KYC data, may be saved on their device or as an encrypted file located proximate to or on databases associated with the processing node 104. The institution 106 may save an encrypted hash of metadata that contains proof of KYC requests, checks, and results in any one of numerous storage locations on the distributed compliance system 100. For example, the information may be stored in cloud servers, server farms, databases, and/or locally.

Profile data comprising metadata for the sensitive data can be used to replace storage of sensitive data itself, by having blockchain enabled metadata stored instead of the sensitive data itself, it is possible to minimize risk to the institutions 106. For example, KYC metadata is stored instead of the actual KYC data. The KYC metadata serves as proof that KYC checks were done on each account associated with a financial institution.

For ongoing KYC checks, financial institutions 106 can log into a portal of the distributed compliance system 100 to request consent from their user to conduct a KYC check. The user 101 sends a consent notification to either the institution 106 or the processing node 104. In an embodiment, the consent notification is a single use public key. In an embodiment, the consent notification is used by the financial institution 106 (i.e., the key) to request a KYC check via the compliance as a service application. In an embodiment, the user 101 receives incentivization by receiving cryptocurrency. In an embodiment, the user 101 receives incentivization in the form of metrics scoring for consenting to KYC checks. In an embodiment, the user 101 receives incentivization in the form of cryptocurrency and metrics scoring for consenting to KYC checks.

Doing this monetizes exposures of data privacy and complying with regulations. In an embodiment, a public key would exist for KYC file viewing and another key would allow KYC check refresh. A check refresh refers to processing the data again.

During a KYC oriented audit process, a financial institution 106 logs in to their access point for the distributed compliance system 100 and pulls samples of KYC sensitive data from a pool of users 101. The sensitive KYC data may be viewed and inspected during the audit. In an embodiment, on the interface of the user 101 a public key log can show the consent for every time their data was used.

Notification of accessing sensitive data, such as KYC data, of a user 101 will meet GDPR's transparency guidelines. In an embodiment, once the audit is over, the audit records are encrypted and stored in a database of the institution 106. In an embodiment, audit records are encrypted and stored in central repository of the distributed compliance system 100. In an embodiment, the user 101 is notified of where their sensitive data is being stored. In an embodiment, the user is permitted to request erasure (the right to be forgotten) of their sensitive data from databases of an institution 106 or the distributed compliance system 100. In an embodiment, the database of the distributed compliance system 100 is a central database. In an embodiment, the database of the distributed compliance system 100 is one of many distributed databases. In an embodiment, the database of the distributed compliance system 100 is a distributed network of encrypted databases containing proof of KYC compliance activity in the form of metadata.

In an embodiment, to encourage users 101 to keep their data within the distributed compliance system 100, the distributed compliance system 100 sends out monthly crypto payments. In an embodiment, to encourage users 101 to keep their data with the distributed compliance system 100, the distributed compliance system 100 sends out yearly crypto payments. In an embodiment, to encourage users 101 to keep their data with the distributed compliance system 100, the distributed compliance system 100 sends out dynamic crypto payments based on time used or months adopted. In an embodiment, if an institution 106 wants to keep data on their servers, and the user 101 consents, the distributed compliance system 100 does not have to compensate for this. In an embodiment, if the distributed compliance system 100 wants to keep this data on their servers in an encrypted fashion, and the user 101 consents, the distributed compliance system 100 can compensate for this.

In an embodiment, institutions have advertising access to wallet interfaces (discussed further below). Prospective users 101 are incentivized for completing client-side sensitive data tasks with privacy. Free or reduced transaction fees are offered in exchange for allowing institutions 106, such as financial companies to advertise on account interfaces of users 101. Institutions 106, functioning as member nodes, earn transactional and validation fees from network transactions as well as being able to onboard new users 101 from a wallet interface. Global and domestic computational resource and storage needs are organized, distributed, and maintained by local and international nodes 105 of the distributed compliance system 100.

By incentivizing digital actions, such as compliance tasks for KYC regulation, the multiple risks can be managed by providing valuable metadata in a hybrid system comprising cryptocurrency and fiat. For instance, correspondent institutions 106 may reduce on-boarding times from six weeks to one week by incentivizing a digitized KYC process. In another example, fulfilling KYC requirements for cross-border transactions over $10,000 via digitized and incentivized KYC processes reduces settlements to hours instead of days.

In an embodiment, metrics that measure and analyze KYC actions per user 101 per institution 106 may also calculate reputation and risk scoring for both users 101 and institutions 106. In an embodiment, the more KYC actions completed, the better the reputation and risk scoring and vice/versa. In an embodiment, KYC compliance is met or exceeded with real-time record-keeping of corresponding metadata (metrics) that confirm completed actions.

In an embodiment, all parties are rewarded with increased reputation scores and post transaction confirmation. In an embodiment, KYC risk management is also applied in real-time, dynamically calculated scores. For regulators, generated metadata of KYC compliance activity assists with real-time, on-demand, remote auditing.

Blockchain 1.0 is implemented in the distributed compliance system 100 to include real-time transactions validation, same day settlements of global payments, and immutable record-keeping. This is the compliance network layer 103 discussed above. Blockchain 2.0 is implemented to include automatic, machine-triggered disbursement of incentives when a smart contract is fulfilled. Smart contracts are used to incentivize machine generated KYC processes. This secondary layer is referred to herein as the transaction network layer 203 in FIG. 2. The transaction network layer 203 forms a secondary layer of the distributed compliance system 100.

In an embodiment, Ethereum's blockchain defines an infrastructure that is implemented in the distributed compliance system 100. Ethereum-based blockchain is used to form microeconomies that form the transaction network layer 203 of the distributed compliance system 100.

The transaction network layer 203 for the distributed compliance system 100 is used to form a digitized, decentralized, interconnected economic model without sacrificing enterprise or sovereign interests. In an embodiment, microeconomies are formed that use Ether to pay fees per transaction. In an embodiment, other cryptocurrencies are used to provide transactional costs.

In an embodiment, each microeconomy may be adapted to mint specialized tokens to incentivize tasks specific to that economy's needs. Ethereum blockchain has the capacity to host thousands of different tokens. Each token is interchangeable with Ether, which in turn has cash currency value. In an embodiment, ether may be adapted to represent any form of fiat currency in the current economy that will be digitized in the future.

In an embodiment, the tokens that are minted from the Ethereum network represent cryptocurrencies whose values are derived from digitized fiat currencies. In an embodiment, tokens that are minted from the Ethereum network represent cryptocurrencies whose values are derived from the underlying service, such as the distributed compliance system 100. For example, on exchanges, tokens are measured in Ether or Bitcoin values. In turn, Ether and Bitcoin values are measured in actual fiat currency.

FIG. 2 shows an example of a diagram showing the transaction network layer 203 and disbursement of crypto currencies commensurate with the implementation of the transaction network layer 203 mentioned above.

In the distributed compliance system 100 the user 101 has a wallet 201. A user 101 may reveal or not reveal sensitive data, such as KYC data, to an institution 106 or to another user 101 with a wallet 201, also known as a Peer-to-Peer (P2P) interaction.

With consent of a user 101 and user-controlled data exposure, regulated institution 106 still can conduct KYC risk management without having to manually gather, analyze, and store any sensitive data. The KYC metrics confirm private compliance by institutions 106 with KYC processes. In this manner GDPR and KYC regulations are satisfied, institutions 106 appease regulators, and users 101 of wallets 201 reserve control over how much data to reveal and to whom, which comply with the GDPR.

One of ordinary skill, upon reading this disclosure, will understand that in addition to implementing the system to conform with GDPR, the system may also be implemented to comply with other privacy-oriented regulations, whether it be in the U.S., the E.U, or in other regions and countries. For example, compliance with HIPAA (Health Insurance Portability and Accountability Act) regulations or IIPPA (Insurance Information and Privacy Protection Act) can be satisfied through the implementation of the same architecture.

FIG. 2 shows that at 222 owners 101 of wallets 201 complete KYC compliance actions by exchanging, providing, or updating sensitive data with institutions 106 or another wallet owner 201. These transactions are validated elsewhere, at 224, by other nodes 105 within the distributed compliance system 100. In an embodiment, at least one other node 105 within the distributed compliance system 100 validates the transaction. In an embodiment, at least two other nodes 105 within the distributed compliance system 100 validates the transaction. In an embodiment, a majority of nodes 105 within the distributed compliance system 100 validate the transaction. In an embodiment, more than seventy percent of the nodes 105 validate the transaction. In an embodiment, a weighted consensus of nodes 105 validates the transaction. That is to say, some nodes 105 are more reliable than other nodes 105 and their respective validation is needed to confirm a transaction. Nodes 105 may be members of the distributed compliance system 100, such as computing systems located with institutions 106 and users 101.

In an embodiment, incentives are deposited in the form of tokens. In an embodiment, incentives are deposited in the form of non-fungible, time-stamped, proof-of-compliance tokens that represent compliance certificates as well as fungible currency or tokens. The proof-of-compliance tokens confirm completions of KYC activity. The proof-of compliance tokens may include actions indicative of transparency that add to one's scores used for KYC activity. In an embodiment, the tokens exchanged are a form of cryptocurrency. In an embodiment, the tokens exchanged are in the form of a digital representation of fiat currency. In an embodiment, the tokens exchanged are in the form of a blend of tokens representing cryptocurrency and fiat currency.

The tokens exchanged for execution of tasks with the distributed compliance system 100 incentivizes and motivates users 101 and institutions 106 to participate in potentially computationally intensive, digitized compliance functions.

Implementations of the tokens in distributed compliance system 100 can be used to foster and incentivize other activities besides financial compliance. For example, in an embodiment, cultivating a garden or forest to offset one's carbon footprint and proving the existence and maintenance of the garden or forest with Internet-of-Things (IoT) sensors fulfils a smart contract. The fulfilment trigger distributes payments so long as the IoT sensors send proof of data that the garden or forest is being maintained. In an embodiment, the implementations of tokens and smart contracts are used to encourage energy conservation. In an embodiment, implementations of tokens and smart contracts are used to encourage recycling. In an embodiment, implementation of tokens and smart contracts are used to encourage healthy eating. In an embodiment, implementation of tokens and smart contracts are used to encourage exercise.

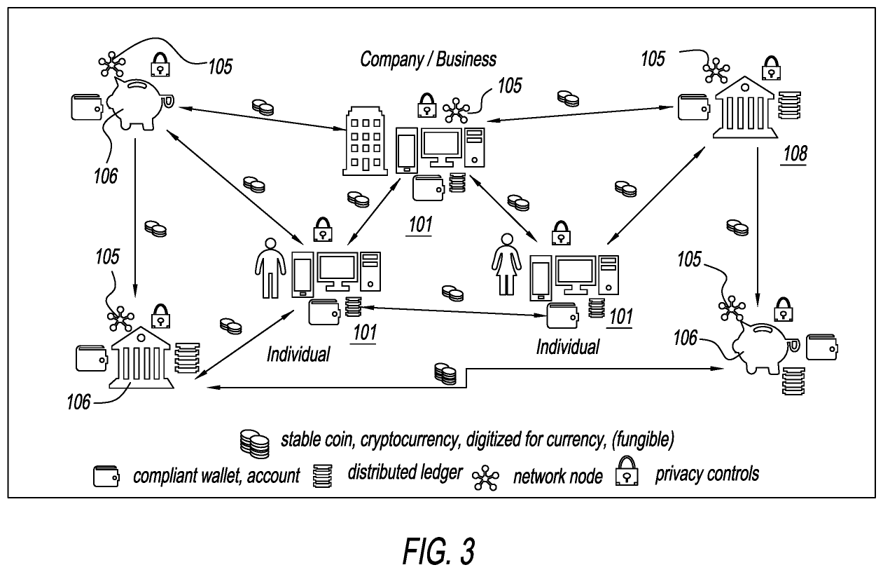

Returning to the financial implementation of the distributed compliance system 100, FIG. 3 shows an overview of KYC-GDPR Compliant Transactions among users and nodes, enabling deposits (inputs) and withdrawals (outputs) for B2B, B2Gov, B2P, P2P. FIG. 3 displays users 101, institutions 106 and regulatory entities 108. Regulatory entities 108 may be those entities that establish the regulations and ensure on a network wide basis that the regulations are being adhered to. In an embodiment, all the entities may function as nodes 105 in the distributed compliance system 100.

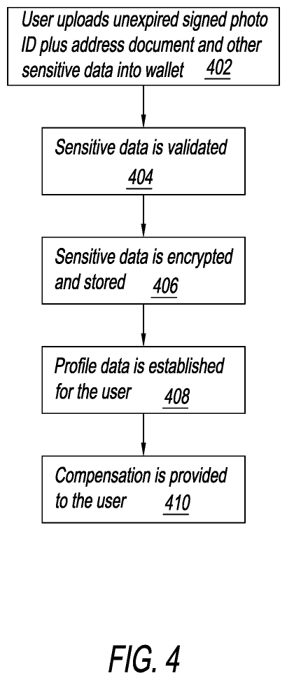

By way of example, FIG. 4 is a flow chart showing the onboarding of users 101 within the distributed compliance system 100. At step 402 a user 101 uploads sensitive data. This sensitive data may be uploaded into a wallet 201 that is operably connected to the distributed compliance system 100.

At step 404 the sensitive data that is uploaded is validated. As discussed above, the sensitive data may be validated at a processing node 104 upon having it transmitted to it by the user 101.

At step 406, the sensitive data is encrypted and stored. As discussed above, the sensitive data may be stored in a distributed fashion or stored locally.

In step 408, profile data is established for the user 101. This profile data may take the sensitive data and process it to create a representation of the user 101 that indicates the relation of the user 101 with respect to the compliance regulations.

In step 410, compensation is provided to the user 101. The compensation may be in the form of a token, which in some instances is a cryptocurrency. The compensation may be provided upon registration or upon completion of some task or whenever another entity or user requests access to the sensitive data of the user 101.

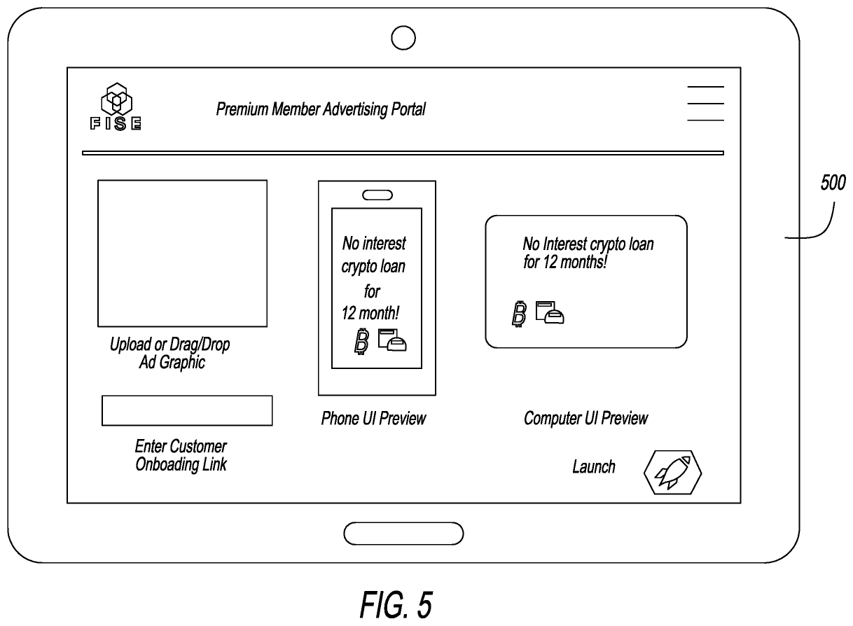

In the distributed compliance system 100 there may be implemented various portals for accessing information and generally interacting with the distributed compliance system 100. FIGS. 5-10 show an example of portals that may be implemented. In particular, the FIGS. 5-10 show portals that may be utilized in a KYC oriented system. For example, online advertising platforms are required to complete KYC on all advertisers in order to meet compliance regulations.

In an embodiment, certain institutions 106 of the distributed compliance system 100, such as insurance agencies, have node privileges to advertise and directly onboard users 101 via a wallet interface.

In an embodiment, users 101 or institutions 106 may additionally be able reach out to other users 101. Users 101 or institutions 106 that are searching for other individuals, similar to classified ads in newspapers but in a consensual, targeted fashion. The user 101 is able to advertise directly to other users 101 who meet specified criteria, thereby sharpening the accuracy of the classified ad section. Users 101 will organize more and more of their sensitive or personal data with their account on the distributed compliance system 100. Their data would not be exposed to anyone but themselves unless they consent to exposing the actual data. But in many cases, they would simply be able to show verification that their data matches the criteria requested. The verification is a representation of their data which confirms that they meet the criteria without having to reveal the actual data. If users 101 consent to having their criteria searched, more relevant connections be it business, personal, or good causes can be made in an incentivized, respectful, and consensual manner.

FIG. 5 shows an advertising access portal 500 that an institution may have access to. In an embodiment, most nodes 105 are incentivized with the ability to advertise and onboard users 101 through the wallet's interface. In an embodiment, all nodes 105 are incentivized with the ability to advertise and onboard users 101 through the wallet's interface.

Still referring to FIG. 5 and the advertising access portal 500, various features may be implemented into the advertising access portal 500. In the embodiment shown in FIG. 5, features, such as an area to upload, or drag and drop an advertising graphic is provided. In an embodiment (not shown in the FIG. 5), the advertising access portal 500 enables an advertiser to deploy ad(s) to a specified demographic including but not limited to user preferences, credit score, income, or purchasing habits. Users 101 may consent to having advertisements displayed on their interface and may also be incentivized for clicking and viewing ads. The advertising portal may also have an area for entering a customer onboarding link. Additionally, provided is an area for viewing a phone user interface preview or a computer user interface preview.

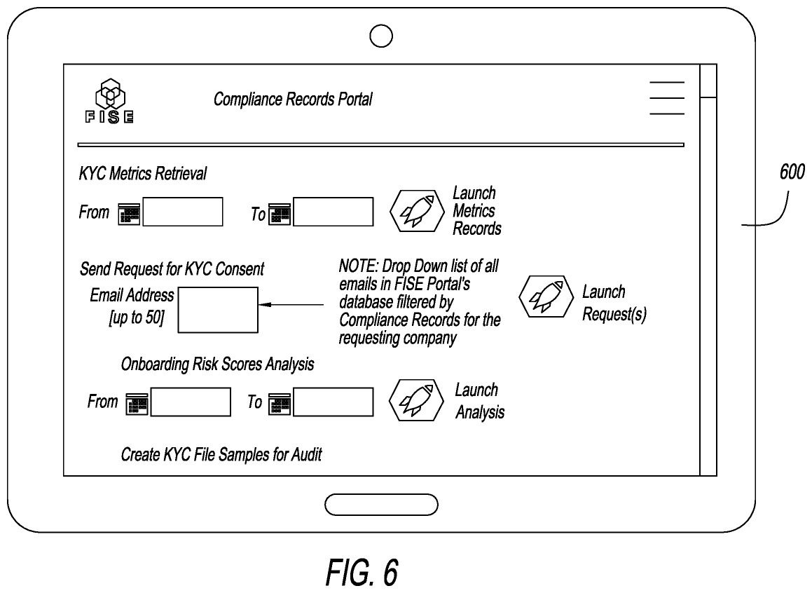

FIG. 6 shows another portal that may be implemented in the distributed compliance system 100. This is the compliance records portal 600. The compliance records portal 600 has access points for KYC metrics retrieval. The compliance records portal 600 also provides access points for sending requests for KYC related data. The compliance records portal 600 may also include a section for onboarding risk scores analysis.

In an embodiment, institutions 106 may view their compliance validations (from their node portal) on a distributed ledger and use the data to bolster their compliance reputation. Options to conceal or reveal scores derived from metadata are within the control of the administrator for an institution.

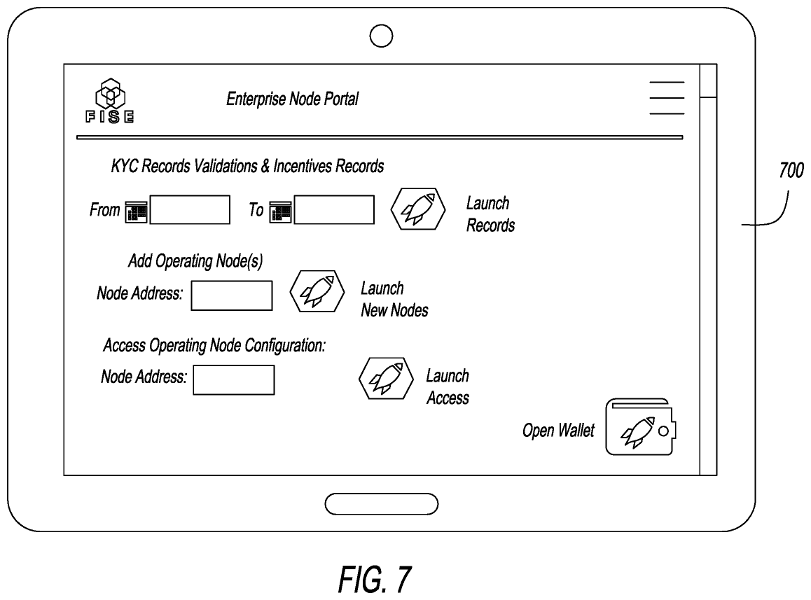

FIG. 7 shows another portal that may be implemented in the distributed compliance system 100. This is the enterprise node portal 700. The enterprise node portal 700 has access points for KYC records validations and incentives records. The enterprise node portal 700 also provides access points for adding operating nodes. The enterprise node portal 700 also provides an access point for accessing operating node configurations.

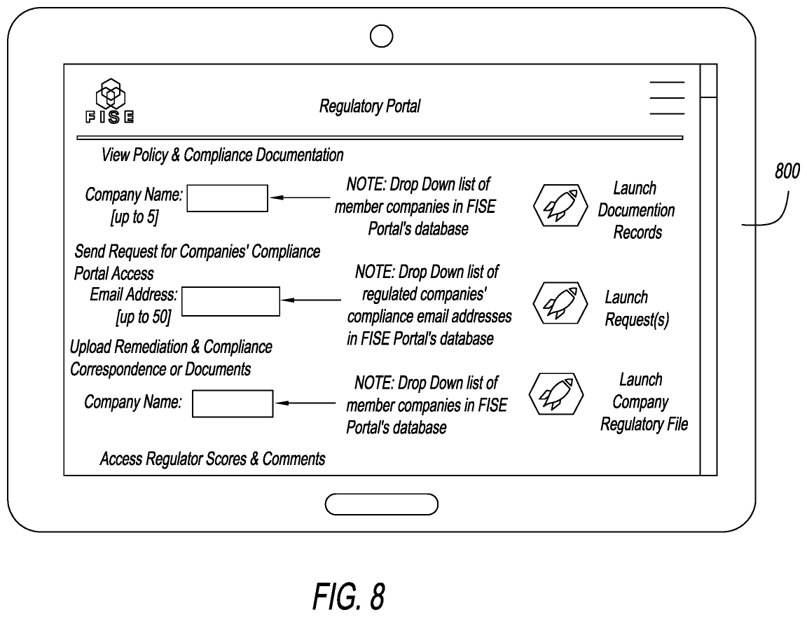

Member regulators for a distributed compliance system 100 may have access to a regulatory portal 800, shown in FIG. 8, which has access to regulated enterprise AML/KYC policies and procedures, requests for disclosure of all compliance activity scores for regulated enterprises to complete on-demand, remote audits. Any sensitive data retrieved may be incentivized and consented to consent by users. Regulated financial services companies save hundreds of billions of dollars when using the distributed compliance system 100 to process, procure, and update KYC files which are securely stored at locations other than the institution.

The regulatory portal 800 allows retrieval of an institution's policy and compliance documentation. Requests for access to an institution's compliance portal may also be completed on the regulatory portal 800. After completing an audit, the regulator may upload any results or correspondence to a company's file. The distributed compliance system 100 will save copies in the regulator's account, and one in the company's account. Records of each upload and distribution are available on the activity log.

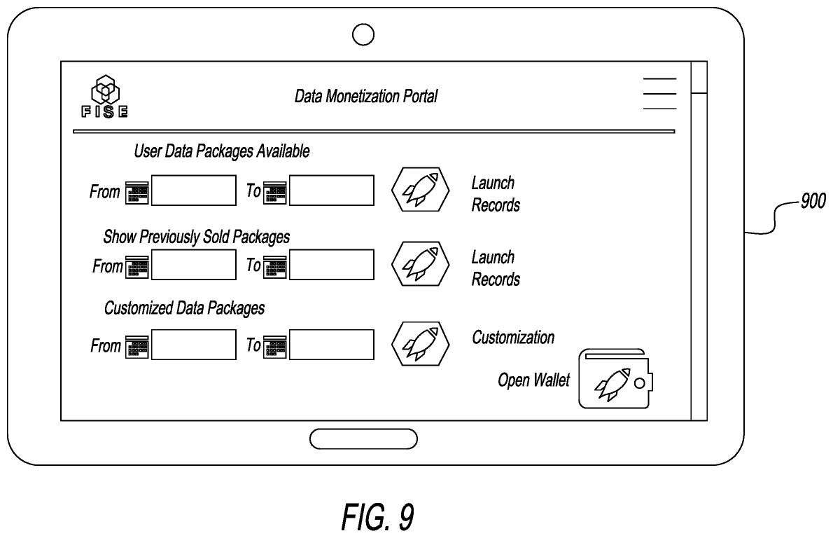

FIG. 9 shows a data monetization portal 900. The data monetization portal provides access for data packages available, previously sold data packages and customized data packages.

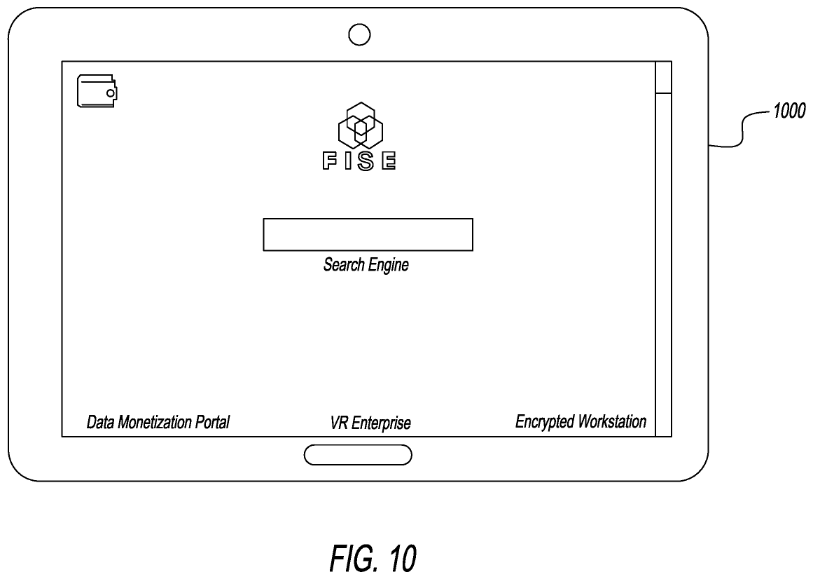

FIG. 10 shows a browser portal 1000. The browser portal 1000 may function as a search engine. All metadata and data including but not limited to buying, selling, visiting certain pages, time spent on certain pages, job searches, word searches, business-related searches, as well as employment related duties may be saved by browser portal 1000.

On a regularly scheduled basis, the user 101 may opt to erase their data, keep their data private, or sell this data to the distributed compliance system 100. In an embodiment, the user may opt to erase their data. Users 101 may customize which data they want to sell and which data to keep or erase. The sale may represent user consent and compensation for their data.

In an embodiment, the browser portal 1000 functions as a search engine and/or map that may be used on any OS and is not restricted to a particular smart phone or computer.

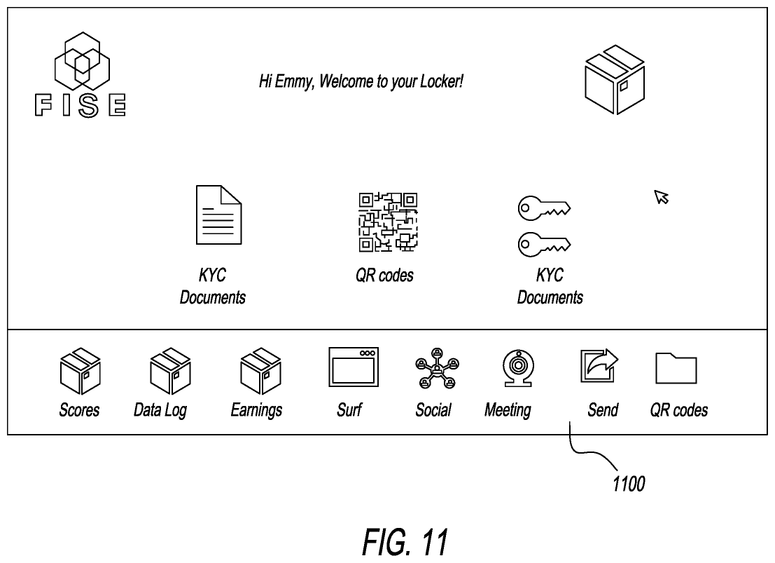

FIG. 11 shows a locker portal 1100 for the distributed compliance system 100 showing a locker that is accessible by a user 101. The locker may contain KYC documents, QR codes, and/or keys. The keys may be private or public keys that the user 101 has access to. The user 101 may have access to the actual KYC documents or have access to metadata that enables the user 101 to access the KYC data or provide access to the KYC data.

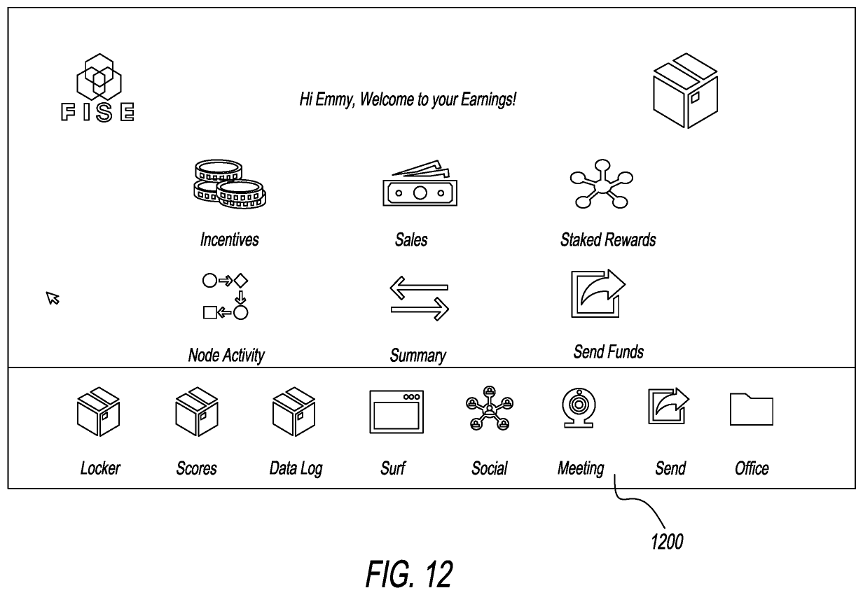

FIG. 12 shows an earnings portal 1200 for the distributed compliance system 100 showing earnings. The earnings portal 1200 can show incentives for the user 101, sales of the user 101, staked rewards of the user 101, and node activity of the user 101. The earnings portal 1200 can also provide a summary of earnings of a user 101. The earnings portal 1200 may also provide a way to send funds.

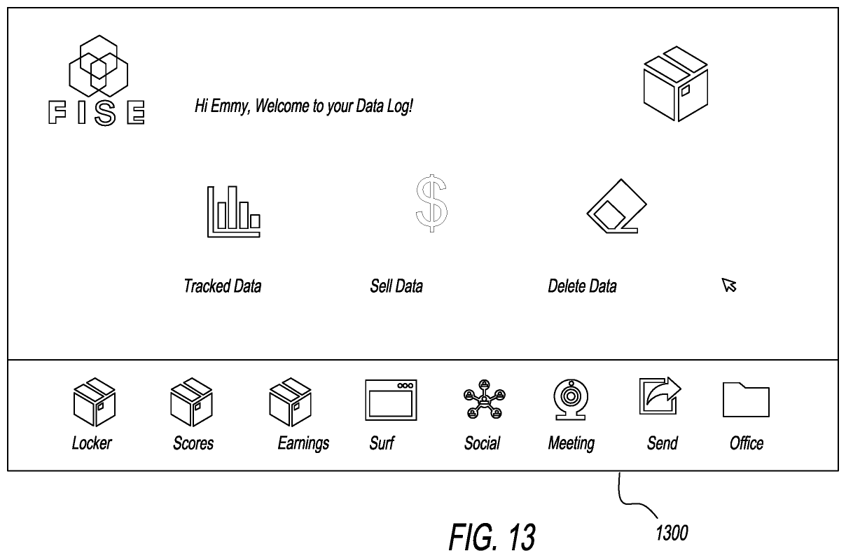

FIG. 13 shows a data log portal 1300 for the distributed compliance system 100 showing a data log. The data log can provide information to the user 101 regarding their tracked data. Additionally, the option for a user 101 to sell their data and/or sensitive data on the distributed compliance system 100 is provided. The data log portal 1300 can also permit a user to delete the data on the distributed compliance system 100.

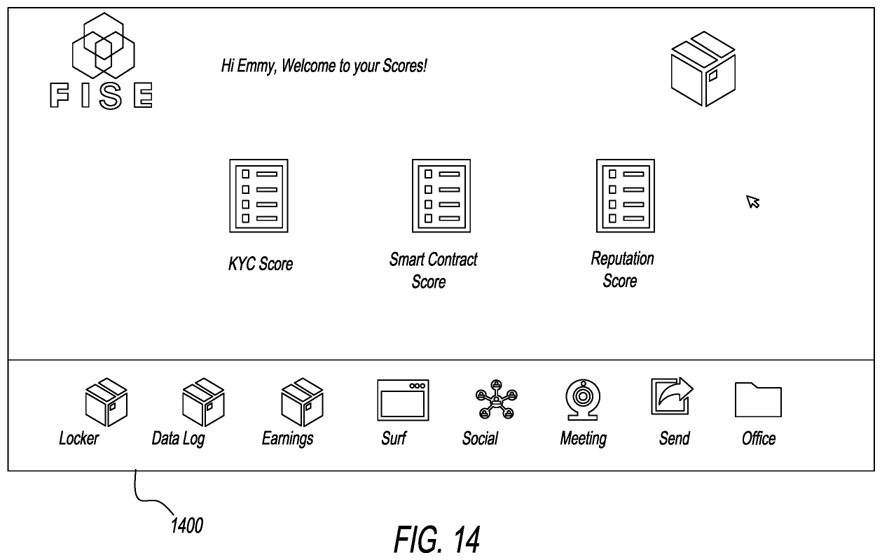

FIG. 14 shows a score portal 1400 for the distributed compliance system 100 showing scores relevant to a user 101. On the score portal 1400 a KYC score can be accessed. Additionally, a smart contract score and reputation score can be accessed by a user 101.

Implementing the distributed compliance system 100 discussed above, with the digitization of fiat currencies, citizens of each country can become users of the distributed compliance system 100 and sign up for a wallet 201 and interact domestically and globally through KYC and GDPR governance. The KYC and GDPR compliant on-boarding of users 101 (banked and underbanked) onto a compliant banking network may be more easily facilitated and transitioned by incentives. Some incentives for owners of wallets 201 include data privacy control, one KYC file instead of several, and the opportunity to build real-time reputation, compliance cooperation scores.

In an embodiment, governments from democratic nations become nodes 105 on the distributed compliance system 100. In an embodiment, individuals of non-democratic nations may become users 101 able to sign up for a wallet 201 under economic refugee status, allowing the individual to interact and participate globally without interference. In an embodiment, governments adhering to predetermined human rights are preferably invited to become nodes 105 on the distributed compliance system 100. In an embodiment, groups adhering to predetermined human rights are preferably invited to become nodes 105 on this distributed compliance system 100. In an embodiment, groups adhering to predetermined civil rights are preferably invited to become nodes 105 on the distributed compliance system 100. In an embodiment, nations adhering to predetermined civil rights are preferably invited to become nodes 105 on the distributed compliance system 100.

The distributed compliance system 100 provides advantages for a variety of users 101 interested in becoming part of the financial system. Banked users 101 who want safe, compliant, streamlined, risk managed access to global payment networks are able to use the distributed compliance system 100 to enact transactions without fear of regulatory risks. Underbanked refugees and undocumented stateless individuals can build compliant digital identities that allow access to liquidity through use of the distributed compliance system 100. Multi-national corporations in need of faster payment settlement times benefit from native KYC-GDPR risk management protocols prior to initiating international fund transfers or to users 101 who prefer digital cash transactions without the middleman by using the distributed compliance system 100.

Correspondent banks in need of automated KYC-GDPR compliant protocols to satisfy KYC regulations with respondent banks and their customers can use the distributed compliance system 100. Established financial enterprises whose KYC practices are out of compliance with the GDPR rule also benefit from a ready to use solution with built in KYC-GDPR compliance automation though use of the distributed compliance system 100. Strategically and compliantly, regulated legacy systems may continue their operations and expand their customer base on a compliant transactions network with the distributed compliance system 100. Companies transact safely and compliantly with regulated banking systems, increasing liquidity in both digitized fiat and crypto realms by using the distributed compliance system 100.

In an embodiment, by using the distributed compliance system 100 all transactions are immutably recorded, thereby enabling sound record-keeping for enterprises who interact locally within a country or globally in several countries. In an embodiment, records of the addresses of wallets 201 and transaction IDs (TxID) are created and available for public search by using the distributed compliance system 100. In an embodiment, KYC compliance records and scores from one wallet may be assigned to new wallet addresses for the same user 101 without replicating KYC files unnecessarily. In an embodiment, storage redundancies and cyber risks are reduced by allowing for one digital KYC file per user 101 no matter the number of financial companies or wallets 201 associated with the user 101.

In an embodiment, addresses of wallets 201 are alpha-numeric and pseudonymous identifiers. Personal data is protected and preferably only visible amongst parties involved in the transaction on a consent-driven basis. Privacy of personal data is concealed, controlled, and portable. In an embodiment, metadata showing KYC compliance checks and scores per wallet 201 are available for participating nodes 105 on the network when the user 101 of the wallet 201 consents to revealing them.

In an embodiment, prospective nodes 105 undergo a background check and KYC checks to ensure that nodes 105 are safe. In an embodiment, prospective nodes 105 are determined to be compliant. In an embodiment, prospective nodes 105 are determined as to their potential to impact reputation. In an embodiment, prospective nodes are determined based on their ability to be cooperative. In an embodiment, prospective nodes 105 are determined to be sustainable. In an embodiment, prospective nodes 105 are determined to be ethical. In an embodiment, prospective nodes 105 undergo all the aforementioned evaluations. In an embodiment, prospective nodes 105 undergo at least one or more of the aforementioned evaluations. In an embodiment, prospective nodes 105 that may not meet standards may have the option to remediate deficiencies through a rehabilitation program. Inclusion via rehabilitation ensures that ethical standards are met while encouraging growth and improvement.

In an embodiment, local or domestically based nodes 105 may act within the national boundaries of their country. In an embodiment, local nodes 105 receive fees for validating and facilitating transactions occurring within their country. Local nodes 105 are able to advertise and directly onboard local customers via the interface for the wallet 201. In an embodiment, internationally based nodes 105 receive fees for validating and facilitating transactions occurring between countries. In an embodiment, international nodes 105 advertise to and directly onboard their customers via wallet 201. In an embodiment, a wallet 201 owned by a user 101 may choose to opt out of advertising by agreeing to transactions fees.

In an embodiment, computational energy may be distributed with respect to sovereign boundaries and laws. In an embodiment, data storage may be distributed with respect to sovereign boundaries and laws. In an embodiment, traffic loads may be distributed with respect to sovereign boundaries and laws. In an embodiment, computational energy, data storage, and traffic loads may be distributed with respect to sovereign boundaries and laws (or any combination thereof).

In an embodiment, quantum key enabled blockchain is implemented to thwart attempts at cryptography hacks. A quantum key backed network enables KYC governance on the distributed compliance system 100 to permit it to operate safely and securely using quantum features. In an embodiment, transactions on the distributed compliance system 100 are quantum key enabled. A quantum key distribution channel enables the secure transmission of sensitive data such as a KYC file to be revealed to an authorized recipient, such as an institution 106 in the distributed compliance system 100.

In an embodiment, with the KYC-GDPR focused distributed compliance system 100, client-centric privacy controls and a singular KYC file per client, the unnecessary redundancy of current KYC processes and non-GDPR compliant practices are addressed. Revealing KYC data and scores are with the control of the user 101 and their wallet 201. In an embodiment, a user 101 may have different wallets 201 on each device they possess or have access to the same wallet on each of their devices (i.e., CPU, Mobile phones, smart watches, etc.). In an embodiment, sensitive data, such as a KYC file, can be coupled to or decoupled from a wallet 201 if the user 101 wants it that way. In an embodiment, each node 105 may contain a light ledger client or a full node (depending on capacity of the particular node 105). In an embodiment, some nodes 105 only take inputs which are updates to the ledger. In an embodiment, other nodes 105 are meant to participate in validating, confirming, and building blocks in the chain. A file containing sensitive data, such as the KYC file, may be saved and encrypted in the cloud, at a node 105, or distributed throughout various nodes 105 depending on the preferences of a user 101.

In an embodiment, cases of repetitive non-consent by a user 101 of a wallet 201 may generate a low transparency score. This low transparency score is generated by activity metrics. This may deem a particular wallet 201 as high risk without violating a particular rule set, such as GDPR privacy rules. In these cases, a regulated institution could simply delay or put on-hold onboarding the user 101 until the user 101 is ready to voluntarily reveal their sensitive data, such as KYC data.

In an embodiment, the distributed compliance system 100, when used for KYC-GDPR compliance, can determine risk at an individual level, instead of at the national level. Current banking regulations discriminate against all users of sanctioned nations based on their geographic citizenry, not on their actions or character as a person. While certain governments fund and hide their criminals, many citizens of oppressed nations continue to be deprived. In the era of digitization, sanctions laws may be applied at a more granular level to blacklist certain individuals versus entire countries.

By taking the granularity of risk down to the user level, humanitarian aid to refugees of sanctioned countries is possible. In an embodiment, the distributed compliance system 100 provides support for displaced, distressed people groups who have lost their homes and communities.

In an embodiment, opportunities to feature games and learning apps via charity contributions or fundraised through smart contracts via the user interface of the distributed compliance system 100 are implemented. Charities and assistance programs can be dedicated for various causes, such as children, refugees, causes to promote peace, the environment, etc. In an embodiment, contributors are recognized with charity scores that they can make public or keep private. In an embodiment, contributors can include this data as part of their sensitive data. In an embodiment, contributors can use this data as part of their KYC information.

In an embodiment, people who are digitally undocumented, may now arrive in any sanctuary country with digital documentation and a KYC compliant, incentivized, authenticated account via the use of the distributed compliance system 100.

In an embodiment, the first transaction in the digital compliance system 100 for a new user is the reward for participating in the digital compliance system 100. In the example of the KYC system, uploading sensitive data such as personal documents, identification cards, selfies, physical address verification or refugee status, a digital KYC profile is created for the refugee. In an embodiment, an individual risk score is procured and the user 101 receives a proof of compliance token indicating they have undergone a KYC check.

In an embodiment, for those who do not have smart phones or access to computers, simple devices with functionalities that facilitate access to the digital compliance system 100 may be implemented. In an embodiment, the device provides access to a wallet 201 for a user. In an embodiment, the device provides access to wallet 201 and mining capabilities. In an embodiment, the device provides a system of hardware and software that captures all actionable data and allows the user to capture, sell, or delete their data.

In an embodiment, each node 105 (institution 106, user 101, wallet 201) has one sensitive data file that may be used to meet regulatory compliance or risk management needs. In an embodiment, the sensitive data file is a KYC file. In an embodiment, each KYC file may be under the control of the user 101 of the wallet 201. In an embodiment, KYC activity may be recorded in a metrics scoring system. In an embodiment, the metrics scoring system includes the number of times a regulated entity has completed a KYC check. In an embodiment, the metrics scoring system includes the number of times a user 101 of a wallet 201 has revealed sensitive data, such as KYC data. In an embodiment, no sensitive data, such as personal data, is revealed in the metrics scoring. In an embodiment, only wallets 201 are revealed by metrics scoring.

In an embodiment, metrics scoring may include scores for transparency. In an embodiment, metrics scoring may include scores for compliance. In an embodiment, metrics scoring may include scores for risk. In an embodiment, metrics scoring may include scores for regulated enterprise accounts connected to a wallet owner. In an embodiment, risk management preferences may be customized per wallet account for peer-to-peer transactions.

In an embodiment, for a distributed compliance system 100 that functions as a KYC platform, KYC file completion that is validated by two operating nodes 105 provides confirmation that the user 101 has completed KYC compliance. In an embodiment, after a user 101 has received confirmation and validation that their KYC file has been created, an invitation is auto-sent to redeem their cryptocurrency that is held in a smart contract. In an embodiment, the smart contract triggers and the cryptocurrency delivered when the user 101 enables their compliant wallet 201 and clicks “receive.” In an embodiment, the compliant wallet 201 is adapted to receive Bitcoin, Litecoin, Ethereum and other cryptocurrencies, such as stablecoins and tokens.

In an embodiment, in a KYC network, the updating of sensitive data that is desirable for a KYC network is important. In an embodiment, sensitive data that is traditionally non-KYC related may also be inputted, uploaded, and updated. Data of this type may include surveys, online actions, GPS logs, IoT sensor actions, receipts, and purchases. Users 101 also have the option not to share their non-KYC data, as non-KYC data is not a condition of being able to participate on the distributed compliance system 100. By rewarding a user 101 each time that sensitive data is updated, it incentivizes a user to continuously update their sensitive data and thereby reinforce the validity of users 101 and the value of their data on the network.

The wallet 201 for the distributed compliance system 100 enables transactions amongst compliant exchanges, enterprises, and banks (peer to business-P2B, business to business-B2B), as well as peer to peer (P2P). In this way, users, nodes, and Internet of Things (IoT) endpoints are compliantly connected to an international banking network that supports hybrid (fiat and crypto) ecosystems.

The user 101 of the wallet 201 has control over sensitive data, such as personal data, when deciding how they want to transact and with whom. When transacting peer to peer, users 101 of wallets 201 may choose how much information to reveal and to whom. In a KYC network, one party needs to assess the risk of the other party before a transaction, requests for KYC information and risk scores may be customized as a prerequisite to transacting. Each user 101 of a wallet 201 may develop lists to categorize each interaction according to their own risk tolerance. A personalized network of trusted wallets 201 may be created for the user 101 in order to build a network of trusted connections. The wallet 201 may hold coins and/or stable coins; it also serves as a gateway for compliance actions incentivized to compensate the user 101 and prevent KYC data leaks.

In an embodiment, the wallet 201 enables organization of sensitive data based on date, wallet owner, trust scores, and any other relevant filters. In an embodiment, default trust scoring metrics are provided and may be implemented in the use of the wallet 201. However, in an embodiment, trust scoring metrics may also be customized per wallet 201. That is to say, the metrics for establishing a trusted wallet 201 may be implemented by the user 101. For example, a user 101 may have additional metrics in place to establish trust. In an embodiment, a user 101 of a wallet 201 may then compare the default trust metrics with their customized trust metrics for analysis. In this way, risk management is built-in and available for users 101 of wallets 201 who want to transact peer to peer pseudonymously, yet safely.

In a distributed compliance system 100, such as KYC focused distributed compliance system 100, in a peer to business transaction, the regulated institution 106 requests KYC validation prior to on-boarding a user 101, and the user 101 consents by choosing to reveal sensitive data. Because the institution 106 may already belong to the distributed compliance system 100, when the user 101 reveals their sensitive data, i.e., KYC data in this instance, the distributed compliance system 100 will send cryptocurrency incentives to the wallet 201 of the user 100 as compensation for exposing sensitive data. The distributed compliance system 100 may also send cryptocurrency incentives to the wallet 201 of the institution 106 as well as crediting their KYC compliance score metrics.

Additionally, in a KYC distributed compliance system 100, the institution 106 may be required to do periodic checks on a regular basis, such as yearly, quarterly, monthly, weekly, hourly. This activity by the institution 106 can also generate incentives, such as tokens, to the user 101 for complying.

In an embodiment, each time a check is completed, the enterprise 106 and the wallet 201 are given compliance points, adding to their compliance cooperation score. In an embodiment, to curb potential abuse, each check incurs a fee for the requester of the sensitive data so that checks are completed on a need-to-know basis.

In an embodiment, revealing score checks and requesting them does not incur a fee but adds cooperation points to a participation or transparency score. The transparency of scores associated with wallets 201 supports privacy, risk management, and regulatory compliance. These actions build time-stamped compliance trust scores for all transacting parties in the system.

In an embodiment, incentives for successful on-boarding of a user 101 may also be used to build an account score for the user 101. The account score can be another useful metric. If an institution 106 sees that a user 101 has a high account score or low risk score, the institution may be willing to spend money to advertise to this user 101 since onboarding would not be an issue.

In an embodiment, monthly subscribing institutions 106 or users 101 at higher-paying membership levels would have access to these metrics and be able to formulate and market products for prospects based on scores that indicate risk, compliance, cooperation, and trust. In an embodiment, products are advertised on the interface of the wallet 201 interface with direct on-boarding capabilities for the higher paying users 101.

In an embodiment, a user 101 of a wallet 201 may opt out of advertising by agreeing to additional fees. Preferably, none of the scores accessed by nodes 105 reveal personal data, only scores and metadata activity on the network associated with the alphanumeric identifier of the wallet 201. If a user 101 wishes to purchase an advertised product or service, the user 101 may then consent to revealing their personal or KYC data if required.

In an embodiment, for users 101 who wish to conduct P2P transactions, payees and payers may request to see certificate hashes for authentication and KYC, or request to see a reputation score. In an embodiment, reputation score may be the inverse of a risk score. If the risk score is low, the reputation score is high, and vice versa. Reputation scores also serve to encourage ethical, compliant behavior in future digitized generations.

In an embodiment, member nodes 105 of distributed compliance system 100 earn fees from proof-of-compliance validations, from monetary transactions, and building the blocks in the chain. Member nodes 105 are allowed advertising access to wallets 201.

In an embodiment, users 101 of wallets 201 who are not nodes 105 but want to advertise may also do so. When a user 101 clicks on an ad, and the user 101 consents to being contacted via email or phone, advertisers increase their sales pipeline.

In an embodiment, when member nodes 105 support the compliant onboarding of users 101, regardless of whether the user 101 opens an account with that member, the node 105 is vested in the distributed compliance system 100 because fees are earned for computational contribution. Contributions include certificate validations, gas fees, transactions validations, and block building. In an embodiment, the distributed compliance system 100 splits the fees with nodes 105.

In an embodiment, nodes 105 have distributed ledger that record certificate validations, which may be shown as proof of participating in external compliance activities. Hashes of the certificate are part of the validation record. Certificate may have an expiration date which is separate from the hash.

In an embodiment, users 101 of wallets 201 may also choose to mask all scores. However, the absence or lack of disclosure of any score may be viewed as a red flag. Risk information may be gathered from scores such as transparency, cooperation, or the absence of either, without revealing personal data. Dynamic risk measurements of behavioral metatdata thereby provide a non-KYC based alternative to measuring risk; one that is pseudonymous.

In an embodiment, the distributed compliance system 100 may be implemented for recording real estate related payments. As mortgages are a transaction with loan providers, rental payments are categorized as P2P or B2P for commercial landlords. The smart contract could be customized to cover fulfilment records concerning the deposit, monthly rent, damages, cleaning, and return of deposit within two weeks of moving out. The smart contract would be deployed between two compliant wallets 201 on the distributed compliance system 100.

For example, in an embodiment, smart contracts deploy scores based on timeliness of monthly rent and deposit return within two weeks of moving out. If the deposit is not returned, the landlord states the reason. If a renter paid rent on time, cleaned, and left no damages, rental deposit score decreases. The score starts at 5 (or some other relevant metric) and increases or decreases by tenths of a point (or some other metric). For rent payments, the smart contract would assign good rental payment scores for the renter. For return of deposit, the smart contract would create a rental deposit score for the landlord.

An example involves a bad acting landlord who refuses to return renters' deposits, even after the renters have cleaned the premises and no damages occurred. Rather than bringing forth a lawsuit a smart contract and its scoring mechanisms might be a start to some form of accountability in situations where governance is lacking.

Online housing boards do not provide any method of scoring regarding landlords of certain properties, which makes it too easy for landlords to steal deposits multiple times without having any form of accountability or self-reflection. The unethical activity goes unrecorded and lack of information about this landlord continues to persist to the detriment of future renters. Thus, a smart contract may serve as a form of awareness to the landlord and renter that detrimental actions will affect scores. In an embodiment, names of score categories may not be hidden by default, but the actual scores themselves may be concealed.

With censorship-resistant records, where a victim may enter records of thievery, risk profiles of bad landlords may be developed to reputationally punish stealing. On the flip side, records which praise good landlords may also be utilized to reward good behavior. Both good and bad behavior are addressed, producing a higher level of accountability and safety for everyone. If a lawsuit does ensue and the plaintiff resident wins, the plaintiff resident may also opt to have a smart contract procured which enforces the defendant's duty to pay the judgement and legal fees. This also applies if the landlord is the plaintiff and wants to enforce a judgement via a smart contract.

Collecting payments on behalf of winning plaintiffs can be difficult. This may be true in small claims cases. A defendant may easily evade payment and any reputational damage, even after the plaintiff has won the lawsuit. Smart contracts and event scoring may serve to dis-incentivize bad actors and reward good behavior. Digital supports such as smart contracts may add P2P or B2P accountability records.

In an embodiment, in the distributed compliance system 100, the number of times a user 101 has revealed a score can be made transparent to the public as a transparency score. The number of times a user 101 has inquired of details involving sensitive data can be credited to an inquiry score.

Furthermore, much like a credit score, in an embodiment, the user 101 may have the right to know and be able to remediate their risk score, generating a remediation score. This serves as a method of inclusion and accountability in assisting users 101 whose risk score prevents them from doing business. By fulfilling an open smart contract, the risk score of the user 101 may be remediated.

In an embodiment, a smart contract for remediation could include records rewarding 12 step group involvement, rehabilitation treatments, and writing a daily journal about their journey to process their pain. The smart contract can be viewed and the user 101 held accountable by a remediation counsellor. Smart contracts that are signed off by the counsellor on a monthly basis will have a positive effect on the user's risk and reputation scores.

In an embodiment, VR enabled glasses are able to interact with the distributed compliance system 100. The VR glasses can take part in conference rooms that allows for meetings inside a virtual conference room via VR gasses and may add an extra layer to the KYC compliance on the distributed compliance system 100.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A distributed compliance system comprising:
at least one user operably connected to a compliance network layer;
at least one institution operably connected to the compliance network layer;
at least one processing node operably connected to the compliance network layer;
wherein the at least one processing node is adapted to receive sensitive data from the at least one user and verify compliance of the sensitive data received with a set of compliance regulations;
wherein the at least one processing node stores the sensitive data and is adapted to provide profile data to the at least one institution based on the sensitive data of the at least one user upon request of the at least one institution; and
wherein the profile data is processed by the at least one institution and the processed profile data informs the at least one institution as to whether the sensitive data of the at least one user complies with the set of compliance regulations.

2. The distributed compliance system of claim 1, wherein the compliance network layer implements blockchain in the handling of sensitive data and the at least one institution is adapted to receive a key from the at least one user.

3. The distributed compliance system of claim 1, further comprising a transaction network layer operably connected to the at least one user.

4. The distributed compliance system of claim 3, wherein the at least one user has a wallet implemented on at least one device, wherein the wallet is adapted to receive cryptocurrency.

5. The distributed compliance system of claim 4, wherein the wallet is adapted to receive cryptocurrency in exchange for the transmission of sensitive data to the at least one processing node.

6. The distributed compliance system of claim 5, further comprising a plurality of nodes operably connected to the transaction network layer, wherein each of the plurality of nodes are adapted to verify transactions of the at least one user.

7. The distributed compliance system of claim 6, wherein transactions of the at least one user are further updates by the at least one user to the sensitive data.

8. The distributed compliance system of claim 7, wherein the transaction network layer implements blockchain in handling the transactions.

9. The distributed compliance system of claim 1, wherein the set of compliance regulations are Know Your Customer (KYC) compliance regulations.

10. The distributed compliance system of claim 9, wherein the profile data and storage of the sensitive data comply with General Data Protection Regulations (GDPR), the Health Insurance Portability and Accountability Act (HIPAA), or the Insurance Information and Privacy Protection Act (IIPPA).

11. A method for establishing compliance with compliance regulations, the method comprising:
transmitting from at least one user sensitive data related to the at least one user, wherein the sensitive data is transmitted over a compliance network layer;
receiving at a processing node the sensitive data related to the at least one user;
processing the sensitive data related to the at least one user to verify compliance of the sensitive data with a set of compliance regulations;
generating profile data based on the sensitive data related to the at least one user;
receiving a request about the at least one user from at least one institution;
transmitting from the processing node to the at least one institution profile data regarding the at least one user; and
determining if the at least one user is compliant with the set of compliance regulations based on the profile data.

12. The method of claim 11, wherein the compliance network layer implements blockchain in the handling of sensitive data and the at least one user transmits a key to the at least one institution.

13. The method of claim 11, further comprising a transaction network layer operably connected to the at least one user.

14. The method of claim 13, wherein the at least one user has a wallet implemented on at least one device, wherein the wallet is adapted to receive cryptocurrency.

15. The method of claim 14, further comprising receiving cryptocurrency in exchange for transmitting sensitive data to the at least one processing node.

16. The method of claim 15, further comprising a plurality of nodes operably connected to the transaction network layer, wherein each of the plurality of nodes are adapted to verify transactions of the at least one user.

17. The method of claim 16, wherein transactions of the at least one user are further updates by the at least one user to the sensitive data.

18. The method of claim 17, wherein the transaction network layer implements blockchain in handling the transactions.

19. The method of claim 11, wherein the set of compliance regulations are Know Your Customer (KYC) compliance regulations.

20. The method of claim 19, wherein the profile data and storage of the sensitive data comply with General Data Protection Regulations (GDPR), the Health Insurance Portability and Accountability Act (HIPAA), or the Insurance Information and Privacy Protection Act (IIPPA).
